(19) United States
(12) Patent Application Publication
(10) Pub. No.: US 2009/0317698 A1
(43) Pub. Date: Dec. 24, 2009

(54) POWER SUPPLY DEVICE

(76) Inventor: Takashi Murata, Aichi-Ken (JP)

Correspondence Address: KENYON & KENYON LLP, 1500 K STREET N.W., SUITE 700, WASHINGTON, DC, 20005, US

(21) Appl. No.: 12/375,971

(22) PCT Filed: Jan. 9, 2008
(86) PCT No.: PCT/IB08/00029

§ 371 Date: Feb. 2, 2009

(30) Foreign Application Priority Data
Feb. 1, 2007 (JP) 2007-023590

(51) Int. Cl. H01M 10/50; H01M 6/50; H01G 2/08

(52) U.S. Cl. 429/62; 429/120; 361/689; 361/502

(57) ABSTRACT

In a power supply device, a power storage body is disposed in a casing that houses a cooling liquid. The power supply device includes oscillation means that oscillates the cooling liquid.

### BACKGROUND OF THE INVENTION

1. Field of the Invention

The invention relates to a power supply device, more specifically, to a cooling control for the power supply device.

2. Description of the Related Art

Power storage bodies, such as battery cells or capacitors, in a power supply device generate heat at the time of charging/discharging. Therefore, by cooling the power storage bodies using a cooling device provided in the power supply device, the temperature of the entire power supply device is controlled to make the output from the power storage bodies constant, to extend the lifetime of the power storage bodies, and to supply constant electric power.

Examples of a method of cooling the power supply device (the power storage bodies) include a gaseous cooling method and a liquid cooling method. In these cooling methods, heat transferred from the power storage bodies to a gaseous or liquid cooling medium is transferred to a casing constituting a part of the power supply device, and then is discharged from the power supply device. The gaseous cooling medium used in the gaseous cooling method is easier to handle than the liquid cooling medium used in the liquid cooling method. However, the gaseous cooling medium has lower heat conductivity than that of the liquid cooling medium. In contrast, in the liquid cooling method, the liquid cooling medium needs to be carefully handled. For example, a sealing mechanism needs to be provided to prevent leaking of the cooling liquid from the power supply device. However, the liquid cooling medium cools the power supply device (the power storage bodies) more efficiently than the gaseous cooling medium, because the liquid cooling medium has higher heat conductivity than that of the gaseous cooling medium.

In recent years, a power supply device, such as a secondary battery or an electric double-layer capacitor (condenser), has been employed as a battery for a hybrid vehicle and an electric vehicle. In such a power supply device, a plurality of power storage bodies are disposed close together to make the power supply device compact, and to output high electric power. Therefore, in most cases, the liquid cooling method is employed, and thus the liquid cooling medium having high heat conductivity is used so that the heat inside the power storage bodies disposed close together is efficiently discharged from the outer peripheries of the power storage bodies.

When the liquid cooling method is employed, the cooling liquid is filled in a casing that constitutes a part of the power supply device, and the plurality of power storage bodies are disposed in the casing in which the cooling liquid is filled. A lid member seals the cooling liquid and a power storage module including the plurality of power storage bodies, in the casing. When the power storage bodies generate heat due to charging/discharging, the heat is transferred to the cooling liquid, and then the heat is transferred from the cooling liquid to the casing. Then, the heat is discharged from the power supply device. At this time, convection (natural convection) of the cooling liquid occurs in the sealed casing, as in the case of gas. The heat generated in the power storage bodies is discharged from the power supply device due to the effect of the convection, and the heat conductivity of the cooling liquid.

Accordingly, if the convection of the cooling liquid is promoted, the power storage bodies are efficiently cooled. Japanese Patent No. 2959298 describes a technology in which an agitator agitates a cooling liquid to generate forced convection of the cooling liquid.

However, in the technology described in Japanese Patent No. 2959298, although the cooling liquid is forcibly agitated, only part of the cooling liquid is agitated. Therefore, each of a plurality of power storage bodies is not sufficiently cooled, and the temperature of the cooling liquid around the power storage bodies varies depending on the portion of the cooling liquid.

That is, the cooling liquid has a strong cooling effect on a part of the plurality of power storage bodies, and has a weak cooling effect on another part of the plurality of power storage bodies. Thus, the cooling effect varies among the power storage bodies, and therefore, the rate at which charging and discharging performance deteriorates varies among the power storage bodies. As a result, the charging and discharging performance of the entire power supply device is not stable. Further, the lifetime of the power supply device is decreased.

### SUMMARY OF THE INVENTION

The invention provides a power supply device in which variation in the temperature of a cooling liquid is reduced.

A first aspect of the invention relates to a power supply device in which a power storage body is disposed in a casing that houses a cooling liquid. The power supply device includes oscillation means for oscillating the cooling liquid.

In the first aspect, the oscillation means may be provided on at least one of the outer surface and the inner surface of the casing. The oscillation means may be provided among a plurality of the power storage bodies.

In the first aspect, the oscillation means may be provided in a corner portion inside the casing. The oscillation means may be provided on a connection member that electrically connects a plurality of the power storage bodies, a retaining member that retains the power storage body, or a fastening member that fastens a plurality of the power storage bodies to form a power storage module. Alternatively, the oscillation means may be provided directly on the power storage body.

In the above-described aspect, the oscillation means may be an oscillating body. The oscillation means may include an oscillating body, and an oscillating plate to which oscillation is transmitted from the oscillating body. Also, in the above-described aspect, the oscillating body may be provided in an end portion of the oscillating plate. Alternatively, the oscillating body is provided in each of end portions of the oscillating plate.

In the above-described aspect, the oscillating bodies provided in the respective end portions may be oscillated such that oscillation phases of the oscillating bodies differ from each other.

In the above-described aspect, the oscillating body may be an ultrasonic oscillator.

A second aspect of the invention relates to a power supply device that includes a power storage module that includes a plurality of power storage bodies; a casing that houses the power storage module; a cooling medium that is filled in the casing; a lid member that covers the casing and seals the power storage module and the cooling medium in the casing; and an oscillating body that oscillates the cooling medium.

In the second aspect, the oscillating body may be provided on at least one of the an outer surface of the casing, an inner surface of the casing, an outer surface of the lid member, and an inner surface of the lid member. In the above aspect, the power supply device may further include an oscillating plate on which the oscillating body is provided.

The power supply device according to the second aspect may further include a temperature sensor that detects the temperature of the upper portion of the cooling medium, and the temperature of the lower portion of the cooling medium; and a temperature control portion that oscillates the oscillating body when a difference between the temperature of the upper portion and the temperature of the lower portion is equal to a predetermined value.

According to the above-described aspect, the variation in the temperature of the cooling liquid can be reduced in the power supply device. Thus, it is possible to provide the power supply device that is highly stable.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is an exploded perspective view of a power supply device according to a first embodiment of the invention;

FIG. 2 is an external perspective view of the power supply device according to the first embodiment of the invention;

FIGS. 3A and 3B illustrate how a cooling medium flows in the power supply device according to the first embodiment of the invention;

FIGS. 4A and 4B illustrate how the cooling medium flows in a power supply device according to a second embodiment of the invention;

FIGS. 5A and 5B illustrate how the cooling medium flows in a power supply device according to a third embodiment of the invention;

FIGS. 6A and 6B show a power storage module of a power supply device according to a fourth embodiment of the invention; and

FIGS. 7A and 7B show a power storage module of a power supply device according to the fourth embodiment of the invention.

### DETAILED DESCRIPTION OF EMBODIMENTS

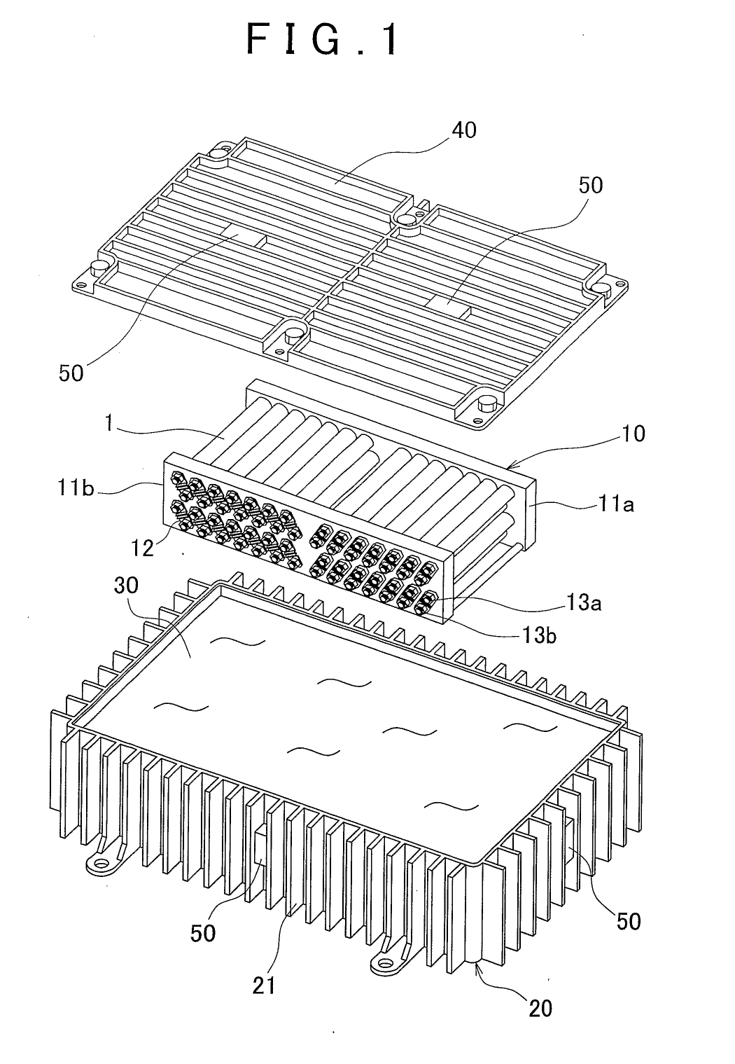

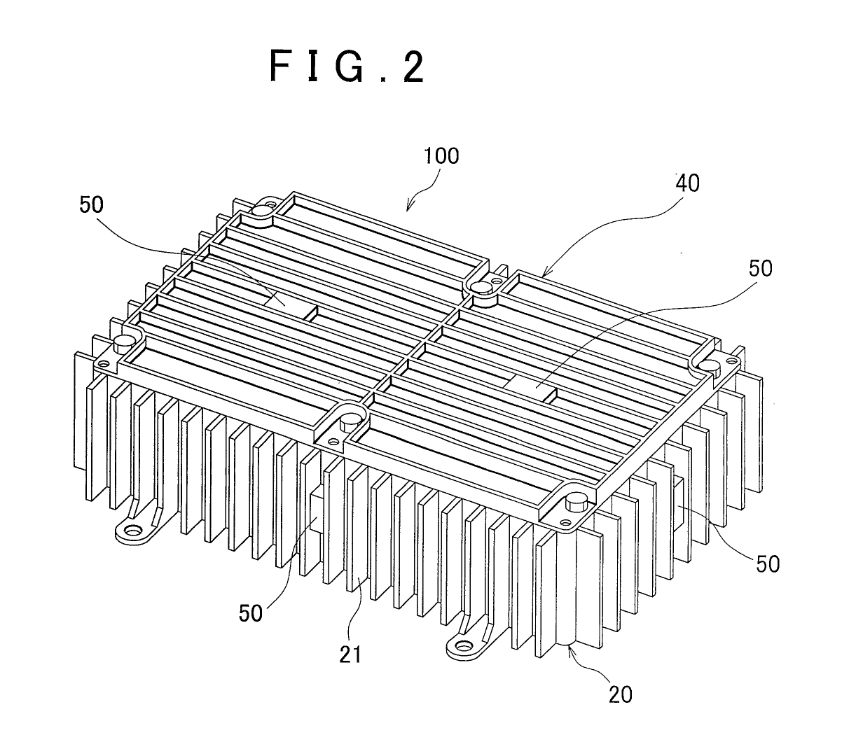

Referring to FIGS. 1 and 2, a power supply device 100 according to an embodiment of the invention includes a power storage module 10, a casing 20, a cooling medium 30, a lid member 40, and oscillating bodies 50. The power storage module 10 includes a plurality of power storage bodies 1. The casing 20 houses the power storage module 10, and is filled with the cooling medium 30. The lid member 40 is placed on top of the casing 20 to seal the power storage module 10 and the cooling medium 30 in the casing 20. The oscillating bodies 50 oscillate the cooling medium 30. As the cooling medium 30 in the embodiment, a cooling liquid such as cooling oil is used. Thus, the power storage bodies 1 are cooled (i.e., the power storage module 10 is cooled) using the liquid cooling method.

Each of the power storage bodies 1 may be a battery cell (unit cell) or an electric double layer capacitor (condenser) in which a positive electrode and a negative electrode are stacked with an electrolyte membrane interposed therebetween. The power storage body 1 has a layer structure including at least one layer. FIG. 1 shows a cylindrical unit cell formed in a cylindrical shape as an example of the power storage body 1. However, the power storage body 1 may have any shape, for example, a square/rectangular column shape.

The power storage module 10 is an assembled battery in which a plurality of power storage bodies 1 are disposed in parallel with each other. The power storage module 10 includes retaining members 11a, 11b, and bus bars 12. The retaining members 11a, 11b are disposed outside ends of the power storage bodies 1 in the lengthwise direction of the power storage bodies 1 such that the power storage bodies 1 are interposed and retained between the retaining members 11a, 11b. The bus bars 12 function as connection members that electrically connect the plurality of power storage bodies 1 in series or in parallel. The power storage bodies 1 are fixed to the retaining members 11a and 11b through the bus bars 12, using nuts 13a, 13b. Bolt portions are provided at ends of the power storage bodies 1 in the lengthwise direction of the power storage bodies 1. The bolt portions engage with the nuts 13a, 13b through the bus bars 12. The power storage module 10 is housed in the case 20 such that the power storage module 10 is immersed in the cooling medium 30 filled in the casing 20.

The casing 20 is provided with a plurality of radiation fins 21 on an outer peripheral surface, and houses the power storage module 10. The cooling liquid, which is the cooling medium 30, is filled in the casing 20. Therefore, a seal is provided inside the casing 20 so as to seal the cooling liquid in the casing 20 and prevent the cooling liquid from leaking. Examples of the cooling liquid include an automatic transmission fluid, silicone oil, and fluorine inert liquids, such as Fluorinert™, Novec™ HFE (hydrofluoroether), and Novec™ 1230, which are made by 3M Company. The casing 20 is filled with the cooling liquid to its maximum capacity, so that gas, e.g. air, does not enter the casing 20.

The lid member 40 is placed on top of the casing 20 so as to seal the power storage module 10 and the cooling medium 30 in the casing 20. The lid member 40 is fixed to the casing 20. The casing 20 and the lid member 40 are made of a metal such as aluminum or copper (or an alloy, e.g., aluminum alloy or a copper alloy). The casing 20 may have a cylindrical shape or a square/rectangular column shape, and the lid member 40 may have a disc shape or a square/rectangular shape.

As the oscillating body 50, an oscillator (an electrostrictive oscillator, a magnetostrictive oscillator) such as an ultrasonic (high-frequency) oscillator, a crystal oscillator, or a piezoelectric element, may be employed. By employing, for example, a tuning-fork oscillator for flexural oscillation, an AT-cut oscillator for thickness-shear oscillation, or a SAW (surface acoustic wave) resonator for surface acoustic wave oscillation, the direction of oscillation may be set to any direction. Each oscillator 50 in the embodiment is provided on the outer surface of the casing 20 (i.e., on the main body of the casing 20 at a position between radiation fins 21), or on the outer surface of the lid member 40. Instead of employing the oscillator that oscillates due to a piezoelectric effect, a device that generates oscillation by mechanically oscillating an object using a motor or the like may be employed.

The power supply device 100 having the above-described configuration is charged and discharged through a positive terminal and a negative terminal of the power storage module 10 housed in the casing 20. Thus, the power supply device 100 supplies electric power.

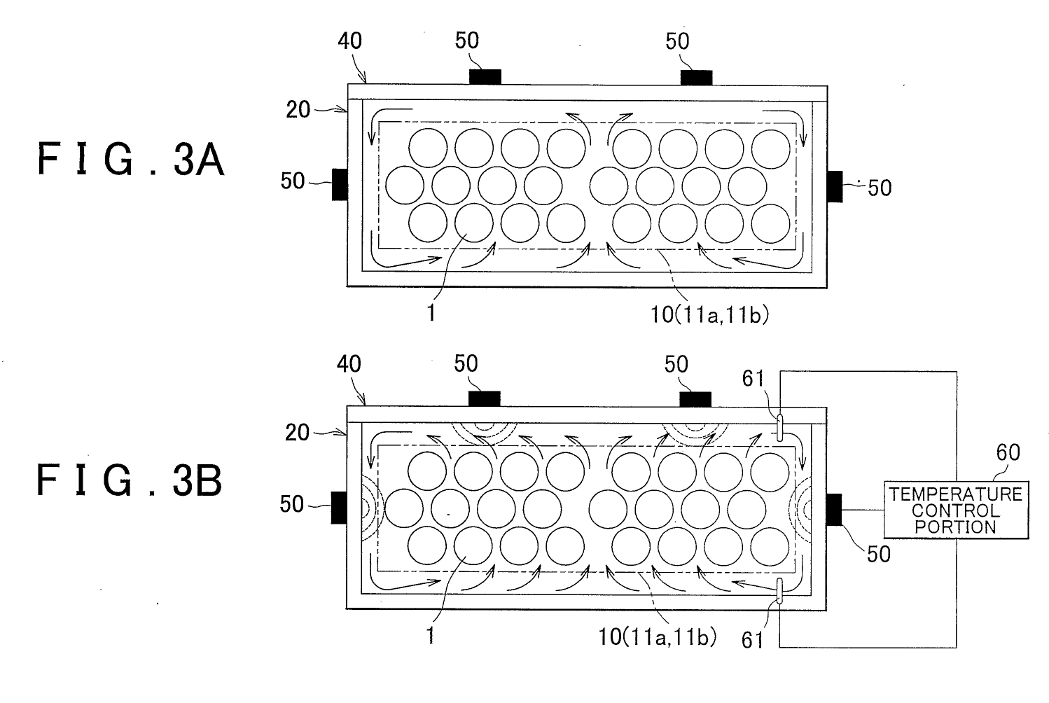

FIGS. 3A and 3B illustrate how the cooling liquid flows when the power storage bodies 1 generate heat due to charging/discharging, and the cooling liquid (cooling medium 30) is warmed. As shown in FIG. 3A, the natural convection of the cooling liquid occurs in the casing 20 due the increase in the temperature of the cooling liquid. Thus, the cooling liquid flows in the casing 20. Generally, the warmed cooling liquid flows toward the upper portion of the casing 20, and reaches the upper surface of the casing 20. After the cooling medium is cooled at the upper surface of the casing 20, the cooling liquid flows from the center of the casing 20 to the outer portion of the casing 20. Then, the cooling liquid flows downward along the outer periphery of the power storage module 10, that is, along the casing 20. Thus, because the cooling liquid is heated by the power storage bodies 1, and cooled by the casing 20, the convection of the cooling liquid occurs in the casing 20.

In the embodiment, the oscillating bodies 50 oscillate the cooling liquid that is naturally convected in the casing 20. As shown in FIG. 3B, a temperature sensor 61 detects temperatures of an upper portion and a lower portion of the cooling liquid filled in the casing 20. A temperature control portion 60 detects, for example, a difference between the temperature of the upper portion and the temperature of the lower portion of the cooling liquid. The temperature control portion 60 drives (applies voltage to) the oscillating bodies 50, thereby oscillating the oscillating bodies 50, when the temperature difference is 2° C. to 5° C.

The oscillation of each oscillating body 50 is transmitted as an oscillating wave, to the cooling liquid via the casing 20. The oscillating wave spreads around the portion of the casing 20, where the oscillating body 50 is disposed. Thus, the oscillation of the oscillating bodies 50 agitates the cooling liquid, thereby promoting the flow of the cooling liquid.

As described above, in the power supply device 100, the oscillation of the oscillating bodies 50 agitates the cooling liquid, thereby promoting the flow of the cooling liquid. Therefore, it is possible to reduce variation in the temperature distribution of the entire cooling liquid, and to equalize the temperature of the cooling liquid in the power supply device 100. Thus, it is possible to avoid the situation where the cooling liquid has a strong cooling effect on a part of the plurality of power storage bodies 1, and has a weak cooling effect on another part of the plurality of power storage bodies 1. That is, it is possible to prevent the cooling effect from varying among the power storage bodies 1. Accordingly, the rate at which charging and discharging performance deteriorates is made uniform in the entire power storage bodies 1. Thus, the stable power supply device can be provided.

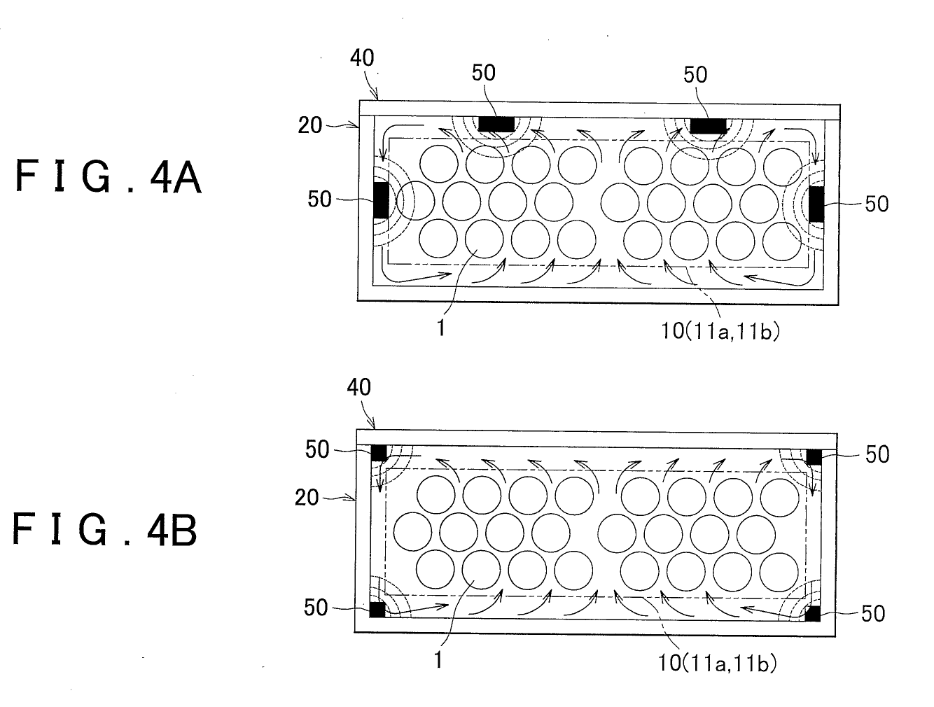

FIGS. 4A and 4B show sectional views of a power supply device according to a second embodiment of the invention. In the first embodiment, the oscillating bodies 50 are provided on the outer surface of the casing 20 and on the outer surface of the lid member 40. In contrast, in the second embodiment, the oscillating bodies 50 are provided on the inner surface of the casing 20 and on the inner surface of the lid member 40. That is, the oscillating bodies 50 are provided such that the oscillating bodies 50 are immersed in the cooling liquid, along with the power storage module 10.

As shown in FIG. 4A, because the oscillating bodies 50 directly oscillate the cooling liquid, the oscillation of the oscillating bodies 50 more effectively promotes the flow of the cooling liquid. The oscillating body 50 may be provided in a corner portion inside the casing 20 as shown in FIG. 4B. Portions of the cooling liquid close to the power storage bodies 1 have high flowability. That is, the portions of the cooling liquid close to the power storage bodies 1 are likely to flow upward due to heat transmitted from the power storage bodies 1. Portions of the cooling liquid in the corner portions inside the casing 20 have low flowability, because the portions of the cooling liquid are far from the power storage bodies 1. Therefore, by disposing the oscillating bodies 50 in the corner portions inside the casing 20, it is possible to promote the flow of the entire cooling liquid, and to make the temperature of the cooling liquid more uniform in the power supply device 100.

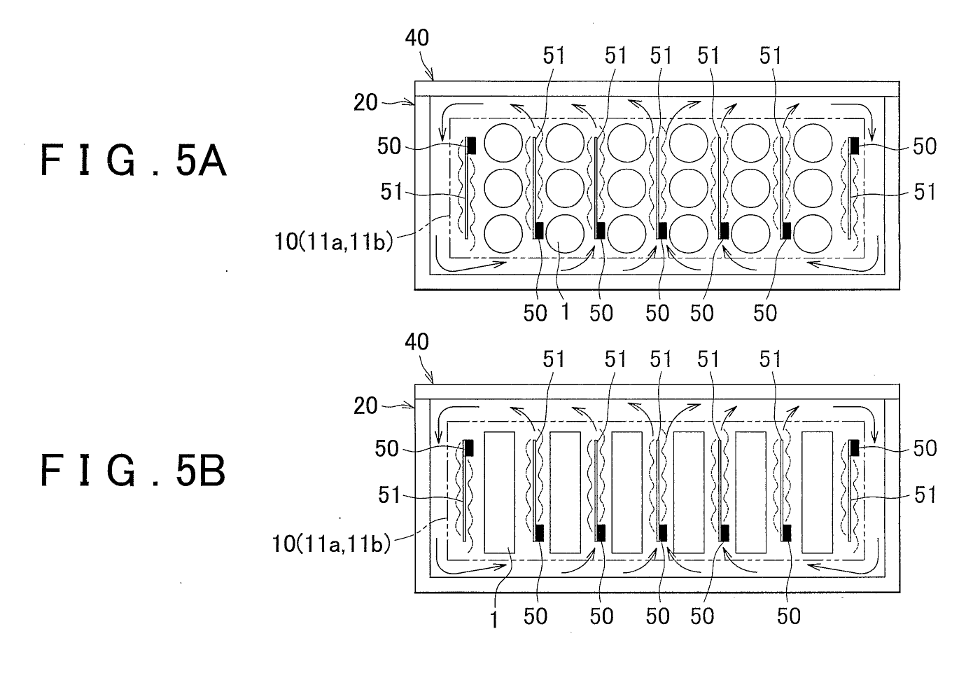

FIGS. 5A and 5B show sectional views of a power supply device according to a third embodiment of the invention. In the third embodiment, the oscillating bodies 50 are provided among the power storage bodies 1 in the power storage module 10. Also, the oscillating bodies 50 are provided outside the power storage bodies 1 in end portions of the casing 20. The amount of heat transferred from the power storage bodies 1 to portions of the cooling liquid flowing in areas among the power storage bodies 1 is larger than the amount of heat transferred from the power storage bodies 1 to portions of the cooling liquid at the outer periphery of the power storage module 10. Therefore, the oscillating bodies 50 promote the flow of the portions of the cooling liquid in the areas among the power storage bodies 1.

Particularly, in the third embodiment, each oscillating body 50 is provided with an oscillating plate 51 so that oscillation of the oscillating plate 51 promotes the flow of the cooling liquid. As shown in FIG. 5A, the oscillating plate 51 extends in the direction in which the cooling liquid flows toward the upper portion of the casing 20 due to convection. The oscillating body 50 is provided in one end portion of the oscillating plate 51.

Accordingly, in the third embodiment, it is possible to promote the flow of the portions of the cooling liquid in the areas among the power storage bodies 1 that constitute the power storage module 10, and to reduce the variation in the temperature distribution of the portion of the cooling liquid around each power storage body 1. Thus, it is possible to equalize the temperature of the cooling liquid in the power storage device 100. Also, by providing each oscillating body 50 with the oscillating plate 51, it is possible to transmit the oscillation of each oscillating body 50 in a wide area of the cooling liquid, and therefore, to more effectively promote the flow of the cooling liquid.

In FIGS. 5A and 5B, in each of the oscillating plates 51 provided among the power storage bodies 1. Thus, the oscillation of the oscillating plates 51 is transmitted in the direction in which the cooling liquid flows toward the upper portion of the casing 20 due to convection. This promotes the convection of the cooling liquid, thereby promoting the flow of the cooling liquid. The oscillating body 50 may be provided in each of end portions of the oscillating plate 51.

FIG. 5B shows an example of the power storage module 10 including the power storage bodies 1 each of which has a rectangular column shape. As in FIG. 5A, the oscillating bodies 50 are provided among the power storage bodies 1, and outside the power storage bodies 1 in end portions of the casing 20. Each oscillating body 50 is provided with the oscillating plate 51. As in FIG. 5A, it is possible to reduce the variation in the temperature distribution of the portion of the cooling liquid around each power storage body 1.

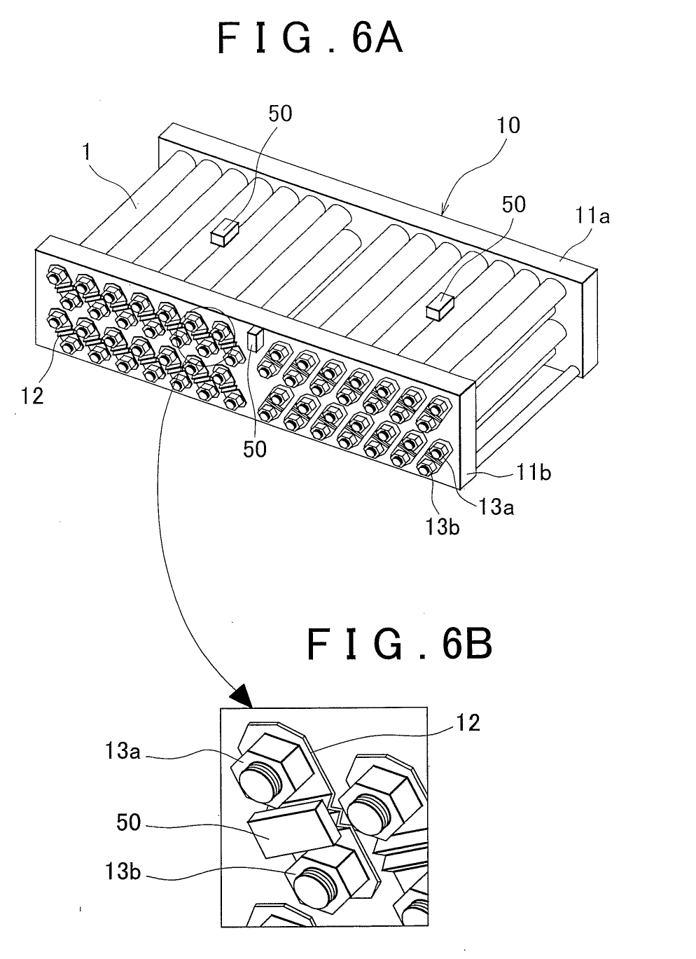

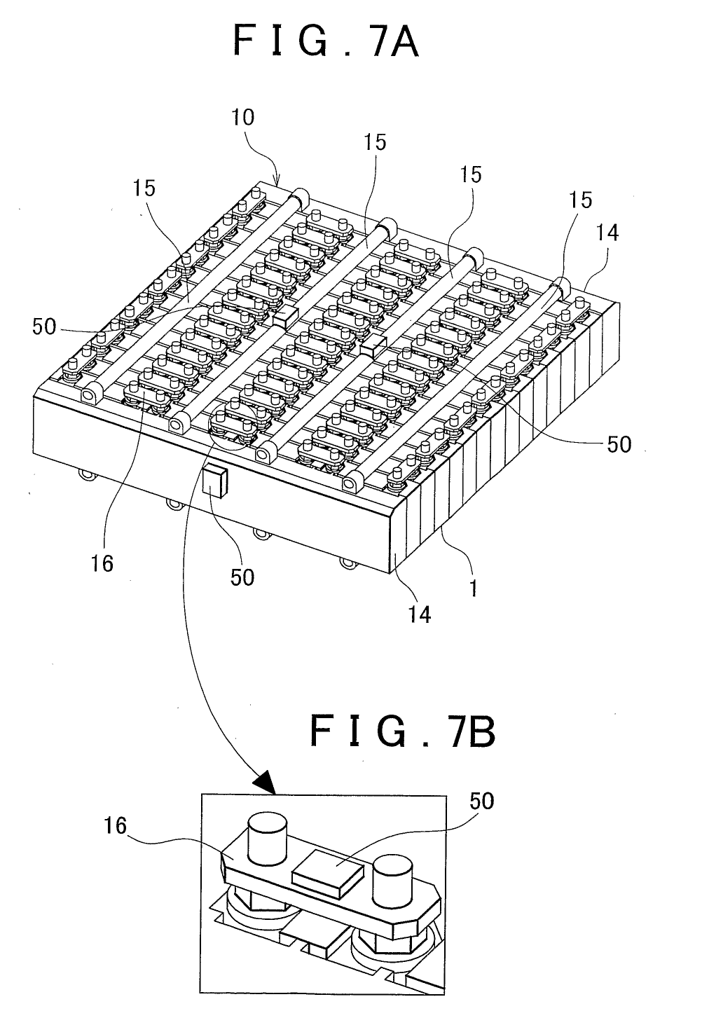

FIGS. 6A and 6B show a power storage module and bus bars of a power supply device according to a fourth embodiment of the invention, respectively. FIGS. 7A and 7B show a power storage module and bus bars of another power supply device according to the fourth embodiment of the invention, respectively. The oscillating body 50 may be disposed on the power storage module 10 (i.e., on the retaining members 11a, 11b), or may be disposed directly on the power storage body 1, as shown in FIG. 6A. The oscillating body 50 may be disposed on the bus bar 12, as shown in FIG. 6B.

FIG. 7A shows the power storage module 10 including the power storage bodies 1 each of which has a rectangular column shape. In this case, the oscillating bodies 50 are provided on fastening members (end plates 14, fastening bars 15, and the like) that fasten the plurality of power storage bodies 1 to form the power storage module 10. Also, the oscillating body 50 may be disposed on the bus bar 16, as shown in FIG. 7B.

In the fourth embodiment, by disposing the oscillating body 50 directly on the power storage bodies 1, or at a position relatively close to the power storage body 1, it is possible to promote the flow of the portion of the cooling liquid at the position relatively close to the power storage body 1, and to reduce the variation in the temperature distribution of the portion of the cooling liquid around the power storage body 1.

Thus, in the above-described embodiments, for example, in the case where the plurality of oscillating bodies 50 are disposed in the casing 20 of the power supply device 100, an oscillator, which oscillates in a direction suitable for the flowing direction of the cooling liquid, may be employed as each of the oscillating bodies 50. For example, in FIG. 4A, SAW resonators may be disposed such that a plane of oscillation of the surface acoustic wave from each SAW resonator extends in the flowing direction of the cooling liquid. In this case, the direction of the oscillating wave transmitted to the cooling liquid matches the flowing direction of the cooling liquid. Thus, it is possible to more effectively promote the flow of the cooling liquid. Also, in FIG. 4B, the AT-cut oscillators for thickness-shear oscillation may be disposed in the corner portions inside the casing 20, where the portions of the cooling liquid have low flowability. In this case, it is possible to improve the flowability of the portions of the cooling liquid in and around the corner portions, and to more effectively agitate the portions of the cooling liquid. The power storage body 1 may supply electric power to the oscillating body 50. In this case, the oscillating body 50 does not need to be connected to a power source outside the casing 20. This reduces the number of components. Also, a sealing mechanism for preventing, for example, leaking of the cooling liquid does not need to be provided.

By using a plurality of oscillating bodies 50, and driving the oscillating bodies 50 such that phases of the oscillating waves from the plurality of oscillating bodies 50 differ from each other, a composite wave may be formed from the plurality of the oscillating waves. More specifically, two oscillating bodies 50 may be used. Accordingly, it is possible to control the flow of the cooling liquid by executing an oscillation frequency control that controls the oscillation frequency of each oscillator using an inverter or the like, in addition to a drive control (voltage control) for each oscillating body. In the third embodiment, the two oscillating bodies 50 may be provided in the respective end portions of the oscillating plate 51, and oscillation phases of the two oscillating bodies 50 may differ from each other. In this case, it is possible to oscillate the oscillating plate 51 with large amplitude or small amplitude.

In the above-described embodiments, a flexible fin may be provided on the surface of the oscillating plate 51, and the fin may agitate the cooling liquid when the oscillating plate 51 oscillates. In this case, it is possible to further promote the flow of the cooling liquid using the oscillation of the oscillating body 50.

The above-described embodiment is described using the power storage body, such as a battery cell or an electric double-layer capacitor (condenser), as one example. However, the invention may be applied to, for example, a fuel cell.

1.-14. (canceled)

15. A power supply device comprising:
a power storage module that includes a plurality of power storage bodies;
a casing that houses the power storage module;
a cooling medium that is filled in the casing;
a lid member that covers the casing and seals the power storage module and the cooling medium in the casing; and
an oscillating body that oscillates the cooling medium.

16. The power supply device according to claim 15, wherein the oscillating body is provided on at least one of an outer surface of the casing, an inner surface of the casing, an outer surface of the lid member, and an inner surface of the lid member.

17. The power supply device according to claim 15, further comprising an oscillating plate on which the oscillating body is provided.

18. The power supply device according to claim 15, further comprising:
a temperature sensor that detects a temperature of an upper portion of the cooling medium, and a temperature of a lower portion of the cooling medium; and
a temperature control portion that oscillates the oscillating body when a difference between the temperature of the upper portion and the temperature of the lower portion is equal to a predetermined value.

19. A power supply device comprising:
a power storage body disposed in a casing that houses a cooling liquid; and
an oscillating portion that oscillating the cooling liquid.

20. The power supply device according to claim 19, wherein the oscillation portion is provided on at least one of an outer surface and an inner surface of the casing.

21. The power supply device according to claim 19, wherein the oscillation portion is provided among a plurality of the power storage bodies.

22. The power supply device according to claim 19, wherein the oscillation portion is provided in a corner portion inside the casing.

23. The power supply device according to claim 19, wherein the oscillation portion is provided on a connection member that electrically connects a plurality of the power storage bodies.

24. The power supply device according to claim 19, wherein the oscillation portion is provided on a retaining member that retains the power storage body.

25. The power supply device according to claim 19, wherein the oscillation portion is provided in a fastening member that fastens a plurality of the power storage bodies to form a power storage module.

26. The power supply device according to claim 19, wherein the oscillation portion is provided directly on the power storage body.

27. The power supply device according to claim 19, wherein the oscillation portion is an oscillating body.

28. The power supply device according to claim 19, wherein the oscillation portion includes an oscillating body, and an oscillating plate to which oscillation is transmitted from the oscillating body.

29. The power supply device according to claim 28, wherein the oscillating body is provided in an end portion of the oscillating plate.

30. The power supply device according to claim 28, wherein the oscillating body is provided in each of end portions of the oscillating plate.

31. The power supply device according to claim 30, wherein the oscillating bodies provided in the respective end portions are oscillated such that oscillation phases of the oscillating bodies differ from each other.

32. The power supply device according to claim 27,
wherein the oscillating body is an ultrasonic oscillator.

33. The power supply device according to claim 19, further comprising:
a temperature sensor that detects a temperature of an upper portion of the cooling medium, and a temperature of a lower portion of the cooling medium; and
a temperature control portion that oscillates the oscillating body when a difference between the temperature of the upper portion and the temperature of the lower portion is equal to a predetermined value.
